(19) United States
(12) Patent Application Publication
(10) Pub. No.: US 2003/0097778 A1
(43) Pub. Date: May 29, 2003

(54) Watercraft stabilizing system

(76) Inventor: Joel James Pippert, Houston, TX (US)

Correspondence Address: JOEL J. PIPPERT, SUITE 100, 10810 OLD KATY ROAD, HOUSTON, TX, 77043, US

(21) Appl. No.: 10/274,166

(22) Filed: Oct. 18, 2002

Related U.S. Application Data
(60) Provisional application No. 60/334,197, filed on Nov. 29, 2001.

(51) Int. Cl. A01M 31/06

(52) U.S. Cl. 43/2; 441/23; 114/294

(57) ABSTRACT

A stabilizing system for watercraft that lowers the point of attachment of the anchor line below the bottom of the hull, typically for a waterfowl decoy mounting.

The device incorporates a hinged vane that allows the vane to move fore and aft to provide 1. stabilization 2. a storage door for the anchor line equipment 3. conversion of the water bourn craft to unobstructed flat bottomed ground use.

The system being forward mounted for windward direction stability.

This is a “Non-Provisional” Patent Application which claims the benefit of U.S. Provisional Application No. 60/334,197, filed Nov. 29, 2001.

### BACKGROUND OF THE INVENTION

1. Field of Invention

The present invention relates to a stabilization system for watercraft by lowering the point of attachment of an anchor line for lateral and longitudinal stability of the watercraft in wind and waves without the weight penalty of a keel.

2. Description of Prior Art

The use of keels for stabilization of anchored watercraft is well known in crowded prior art. The most common stabilization system is a weighted keel where the anchor line is attached to the front of the keel or to the front of the hull.

A second system used in prior art is an open keel usually of horizontally tubular shape that fills with water and offers some resistance to movement because of the resistance to movement of water in the tube. Some systems use parameter or side mounted shapes to also cause resistance of movement in water through displacement. These systems have many disadvantages. The first system, that of weighted keels causes a weight penalty. The second systems has more limited use as a stabilizer as it is dependent on undisturbed water to provide stabilization but is generally too shallow to be effective.

Both systems limit transportation and storage and neither system can be used for field use in waterfowl decoys. The weighted keels set up oscillations that tend to destabilize and the water reaction keels are too shallow to key to undisturbed water.

### SUMMARY OF THE INVENTION

The invention is a radical departure from the many problems and limitations associated with prior art units. The new invention, by considerably lowering the anchor attachment point provides superior stability while providing a flat base to the hull when the anchor is not deployed.

The invention also provides a cover for anchor and anchor line storage while maintaining a flat unobstructed base to the watercraft or decoy.

It is an objective of the invention to provide a simple, more effective system of stabilization using a drag on the anchor line at a generous depth to provide stabilization rather than the predominantly shallow and weight dependent systems of prior art.

It is a further objective of the invention to provide fore and aft stabilization by spring loading the stabilization hinge to restrict fore and aft movement mechanically in addition to water displacement.

While the present invention has been described with respect to a limited number of embodiments, those skilled in the art will appreciate numerous modifications and variations therefrom. It is intended that the appended claims cover all such modifications and variations as fall within the true spirit and scope of this present invention.

### DETAILED DESCRIPTION OF THE PREFERRED EMBODIMENTS

Referring to FIGS. 1 through 3 there is shown a typical waterfowl decoy body 1 having a cavity 2 in its base 3. Attached to the base 3 is a hinged vane 4 hinged horizontally, parallel to the base 3 and at right angle to the longitudinal centerline 5 of the body 1. Anchor line 6 is attached to anchor attachment point 7 of the vane 4.

In FIG. 2 the vane 4 is shown deployed and also shown in a closed position as a door 8. The vane 4 in this position also provides for the unobstructed flat bottom 3 required for transportation storage and field decoy requirement.

Referring to FIG. 3, the stability of the system is illustrated by small angle 9 of lateral movement about the anchor attachment point 7 in wind or rough water conditions.

Referring to FIG. 4, the prior art use a shallow keel 10 and an anchor line attachment 11 above the base 3 level providing almost no lateral stability in wind or rough conditions.

### BRIEF DESCRIPTION OF THE DRAWINGS

FIG. 1 is a three quarter view of the vane version showing the vane deployed with the anchor line attached and the anchor and equipment storage area open.

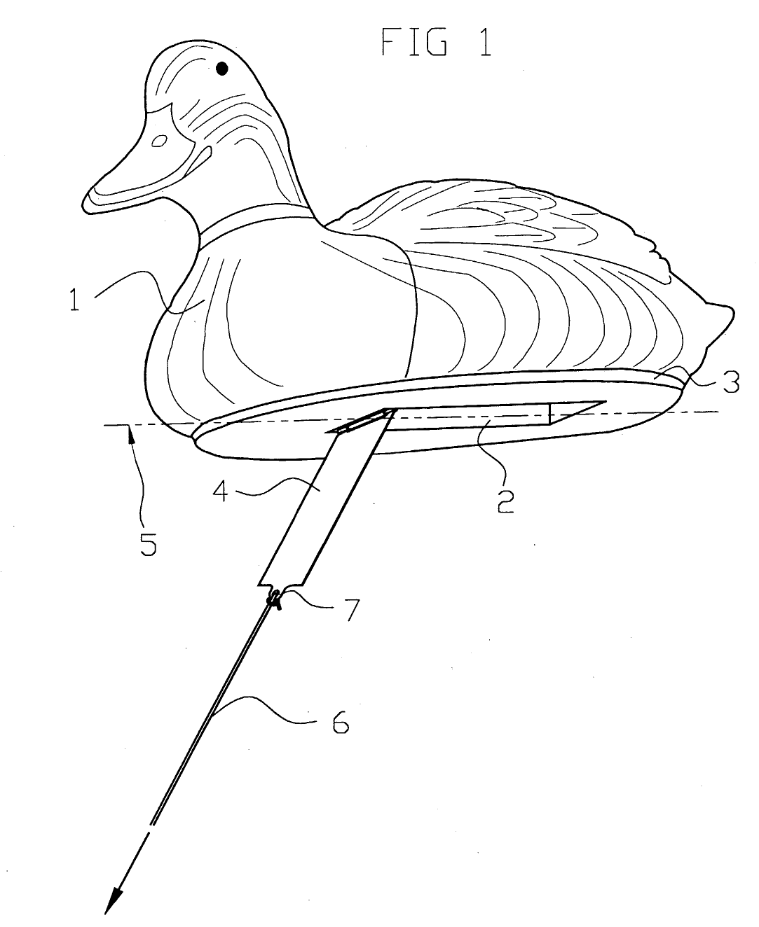

FIG. 2 is a cross section showing the deployed vane and the position of the vane as a door for the storage area.

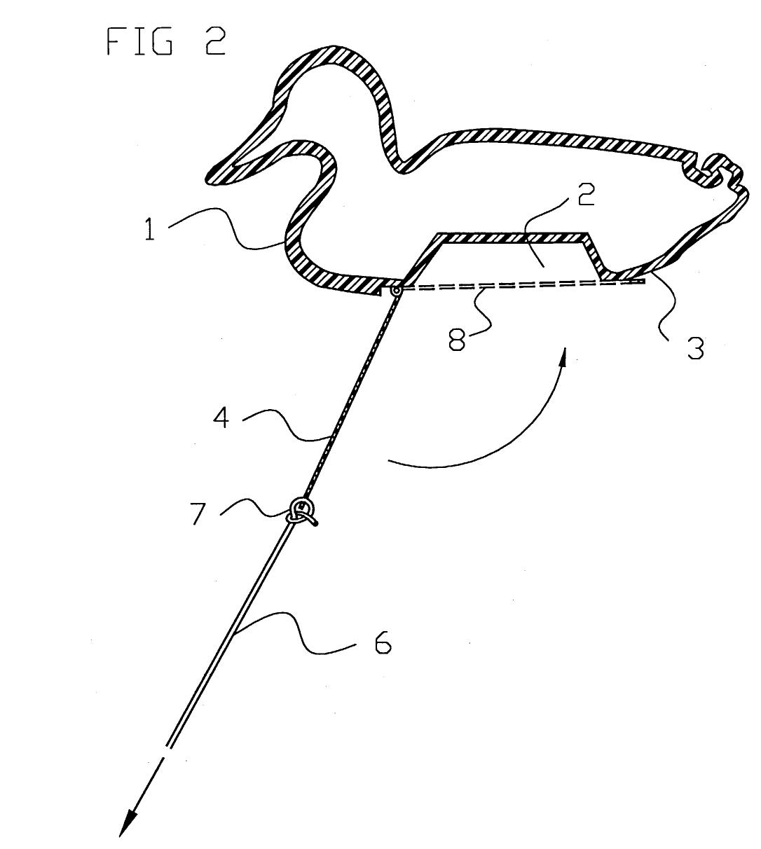

FIG. 3 is a front elevation illustrating the lateral stabilization of a decoy by lowering the anchor line attachment mount.

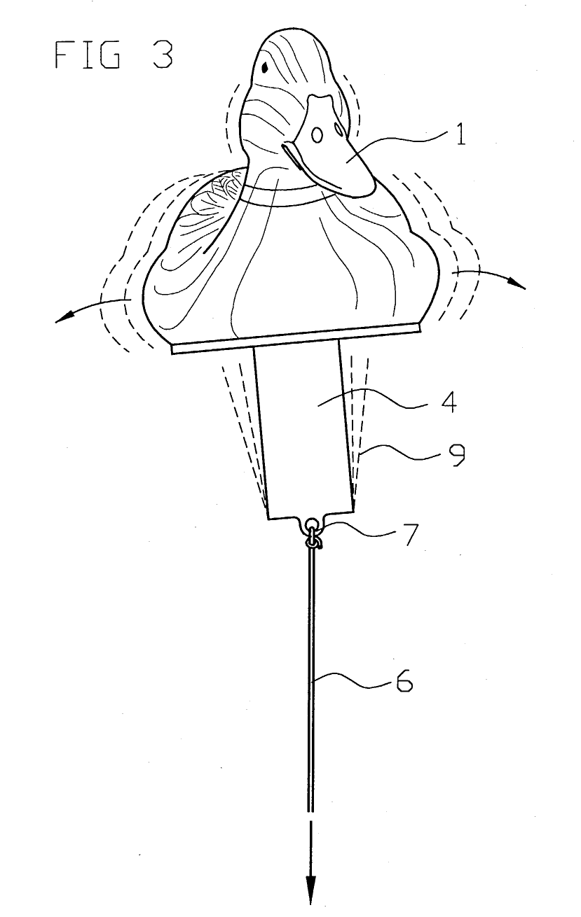

FIG. 4 is a front elevation of a decoy showing restricted lateral stabilization caused by a high level attachment anchor point and a shallow keel.

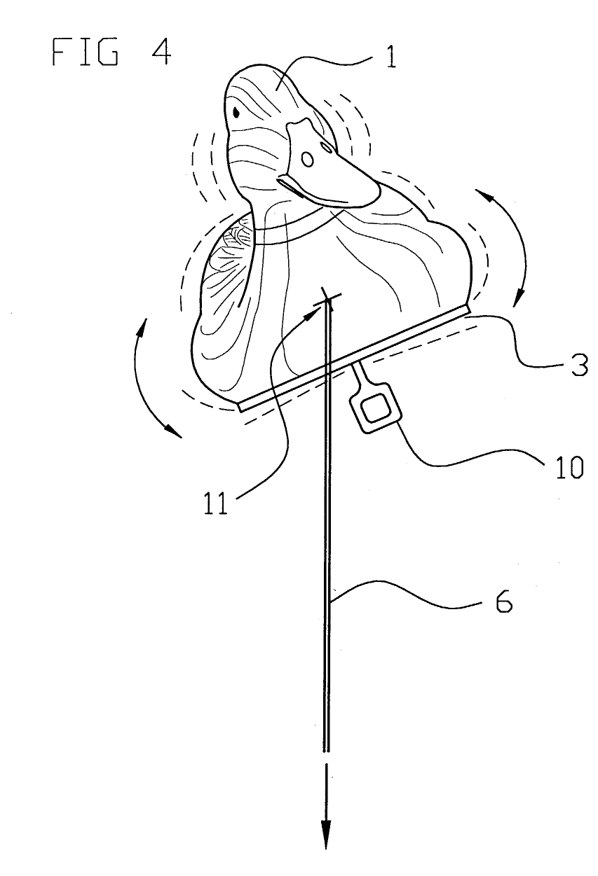

What is claimed is:

1. A system to provide lateral and longitudinal stabilization of a watercraft on the surface of a body of water in the event of wind and waves, the system comprising:
A rigid frame attached to the bottom of a watercraft, that extends below the hull to which an anchor line can be attached to the lowest extremity, causing the watercraft to pivot around the lowered connected point and causing resistance of the frame movement in the undisturbed water at this depth to provide further stabilization to the watercraft.

2. A system to provide lateral and longitudinal stabilization of a watercraft on the surface of a body of water in the event of wind and waves, the system comprising:
(a) A frame attached to the bottom of the watercraft by a hinge having its horizontal centerline at right angles to the longitudinal centerline of the watercraft that extends below the hull to which an anchor line can be attached to the lowest extremity, causing the watercraft to pivot around the lowered connection point and causing resistance of the frame movement in the undisturbed water at this depth to further improve stabilization to the watercraft.
(b) A latch means to hold the frame after being hinged up to the bottom of the watercraft to provide for transportation and storage of the watercraft and land use of waterfowl decoys.

3. A stabilization system according to claim 2 that incorporates a vane instead of a frame to further improve longitudinal stabilization through higher resistance to water displacement.

4. A stabilization system according to claim 3 that uses the vane to provide a door to an anchor or other storage cavity in the base of the watercraft.

5. A stabilization system according to claims 2-4 that has a strut means to hold the frame or vane in a fixed position for optimum stabilization and anchoring angle.

6. A stabilization system according to claims 2-4 that incorporates a spring or shock absorber that provides a limited fore and aft movement of the frame or vane for controlled stabilization.

7. A stabilization system according to claims 2-4 that incorporates spring means to hold the frame or vane in a closed position on the bottom of the hull of the watercraft or in the fully deployed position for anchor line attachment.

8. A stabilization system according to claims 1-7 that uses a semi-flexible structure attached to the bottom of a watercraft to provide better resistance to damage to the structure and to objects in the vicinity of the watercraft.
